(19) United States
(12) Patent Application Publication
(10) Pub. No.: US 2001/0036016 A1
(43) Pub. Date: Nov. 1, 2001

(54) Separation prism assembly

(76) Inventor: Hsiao-Chung Lu, Hsinchu (TW)

Correspondence Address: NATH & ASSOCIATES, 1030 15th STREET, 6TH FLOOR, WASHINGTON, DC, 20005, US

(21) Appl. No.: 09/835,522

(22) Filed: Apr. 17, 2001

(30) Foreign Application Priority Data
Apr. 26, 2000 (TW) 89206838

(51) Int. Cl. G02B 27/14; G02B 27/12

(52) U.S. Cl. 359/634; 359/636; 359/639; 359/640

(57) ABSTRACT

The present invention relates to a separation prism assembly, comprising a plurality of optical lenses and a base. These optical lenses are assembled with a cross shape to form the separation prism and further to split incoming light into red, green and blue, by selectively reflecting and filtering, and these three colors are guided into each propagation direction. The base is formed by several mutually independent positioning components. These positioning components have trapezoid contours and are pasted onto the bottom of the separation prism to define the included angle between the optical lenses for setting up the relative positions thereof. An opening is formed by the surrounding area of the trapezoid's top contour and the optical lenses in order to further improve the separation prism's heat dissipation.

### FIELD OF THE INVENTION

This invention relates to separation prism assembly for orientating relative positions of different separation prisms with a beam-splitting effect, and specifically relates to separation prism assembly, applied to a projective liquid crystal display, for simplifying complex assembly as well as promoting the manufacturing yield.

### BACKGROUND OF THE INVENTION

Separation prism is an optical device made up of several optical lenses with different angles in between for splitting incoming light, according to different wavelengths, into beams with a different spectrum. Generally, separation prism can be applied in many optical instruments, for example, a LCD projector is one of applications. The LCD projector is a set of projective optical systems, i.e., an instrument, which projects images, generated from a liquid crystal panel, onto the screen. The function of the separation prism of an optical system is to separate the incoming light into three-color bands, for example, red, green, and blue, the three primary colors, by means of selectively reflecting and filtering. Subsequently, these three beam components are guided into a predetermined path, and are focused, via lenses, to generate an image on a screen.

As shown in FIG. 1, a traditional fixed separation prism assembly 10 comprises a base 12, on the bottom, and a frame 14, perpendicular to base 12. An opening 20 is located on the central area of frame 14 to let the light go through it and arrive at separation prism. Furthermore, the top edge of frame 14 extends outward to show a flange 16 with a triangular appearance, while one bevel edge of flange 16 is used as the area adjacent to optical lenses for fixing the optical lenses onto prism assembly 10.

As shown in FIG. 2, the first optical lens 22 is first pasted onto one bevel edge of flange 16, and next, the second optical lens 26 is then pasted onto the first optical lens 16 along the other bevel edge of flange 16. The included angle, between the first and the second optical lens 22 and 26, is determined by the angle of flange 16. Subsequently, the third optical lens 24 is also pasted onto the first optical lens 16 and located right ahead of the second optical lens 26. Since the surfaces of the first, the second, and the third optical lens 22, 26 and, 24 are coated with special chemical materials, the separation prism assembly, with a cross shape, therefore splits the incoming light into three color bands, the red, green, and blue primary colors, with different paths, by means of selectively reflecting and filtering.

Traditionally, the fixture work of a prism assembly, onto the optical instrument, needs manual operation. Moreover, it is difficult to paste a plurality of optical lenses respectively onto the instrument, while maintaining the precision of the included angles inbetween. As a result, the throughput and yield rate of separation prism manufacturing is neither high, nor the precision of reflected light from prism is easy to control. However, the materials coated on the surface of optical lenses can recognize the energy of light and transform it into heat. After a period of time of usage, because of no proper design for heat dissipation in the traditional prism assembly, the temperate therein will increase gradually and result in the severe problem of reliability.

### SUMMARY OF THE INVENTION

It is an objective of this invention to provide a mechanism comprising a plurality of optical lenses such as a separation prism with a beam-splitting effect.

It is another objective of this invention to provide an assembly for a separation prism used in the liquid crystal display to simplify assembly difficulty, to increase throughput as well as to improve the heat-dissipation effect.

The invention discloses a first optical lens, a second optical lens, a third optical lens, a based positioning component, a first positioning component, a second positioning component, and a third positioning component. The second optical lens is pasted onto the axis of the first optical lens, while the third optical lens is pasted onto the axis of the first optical lens and located on the other side opposite to the second optical lens to form a separation prism with a cross shape. The based positioning component comprises a triangular contour and the apex of the based positioning component coincides with the cross axis of the first and the second optical lenses, and the two bevel edges of the based positioning component are fit in with the sides of the first and the second optical lenses. The first, the second and the third positioning components comprises trapezoid contours pasted onto the first, the second and the third optical lenses to fix the relative positions there-between. An opening is formed on the tops of the optical lenses to facilitate heat dissipating from the separation prism.

### BRIEF DESCRIPTION OF THE DRAWINGS

FIG. 1A schematically illustrates a traditional separation prism assembly.

FIG. 2 schematically illustrates the separation prism made up of optical lenses pasted onto traditional prism assembly.

FIG. 3 schematically illustrates a path of light propagation in a LCD projector, which separation prism assembly is applied therein.

FIG. 4 schematically illustrates three-dimensional separation prism of the present invention.

FIG. 5A schematically illustrates a top-view of separation prism made up of positioning components and optical lenses of the present invention.

FIG. 5B schematically illustrates a front-view of separation prism made up of positioning components and optical lenses of the present invention.

FIG. 5C schematically illustrates a side-view of separation prism made up of positioning components and optical lenses of the present invention.

FIG. 6 schematically illustrates a top-view of another embodiment of separation prism assembly of the present invention.

FIG. 7 schematically illustrates a top-view of the third embodiment of separation prism assembly of the present invention.

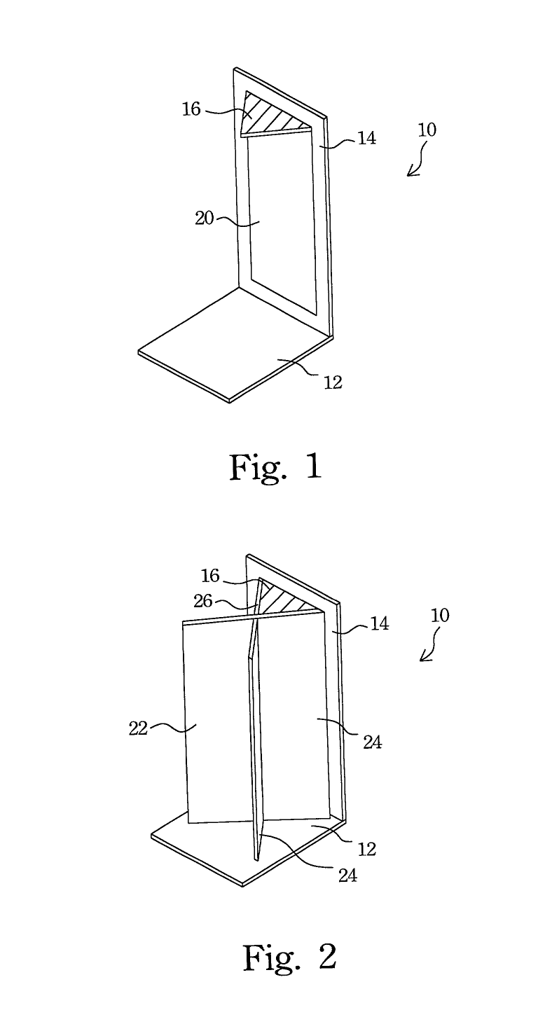

### DETAILED DESCRIPTION OF THE PREFERRED EMBODIMENT

The present invention relates separation prism assembly, which comprises a plurality of optical lenses fixed onto a base, with a cross shape and an included predetermined angle there-between, and then it is configured into an optical instrument together with the base. For the present invention's base it is made up of several positioning components, such as, trapezoids or triangles, accordingly, the optical lenses can be merged with these positioning components to form separation prism assembly simply and precisely. An opening will be generated on the bottom of the prism assembly, after the combination of the positioning components and the optical lenses, so that the heat dissipation effect will be improved. A following LCD projector example will be made as following, and applications and functions of separation prism assembly will also be introduced briefly. Subsequently, several preferred embodiments will be illustrated to show the spirits of separation prism assembly of the present invention.

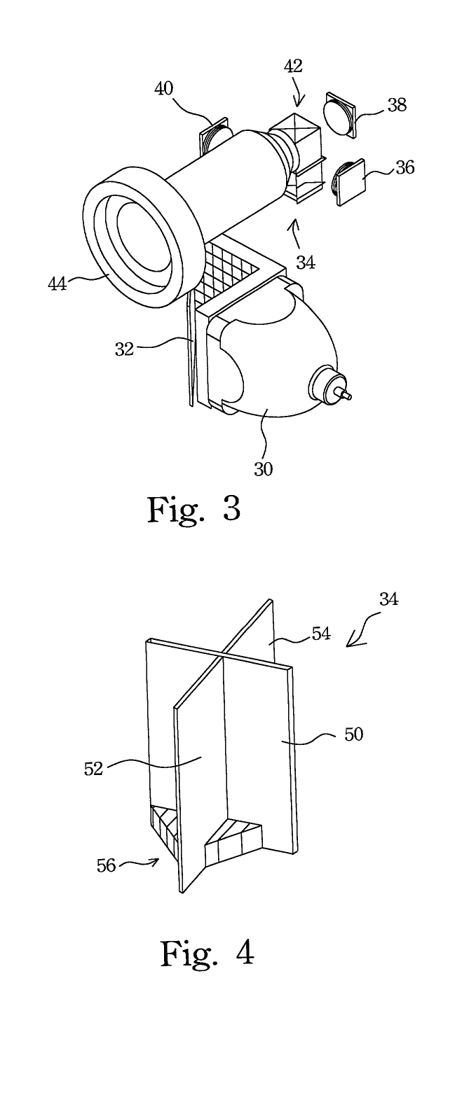

Please refer to FIG. 3, a path of light propagation in a LCD projector, which separation prism assembly is applied therein, is illustrated. As shown in FIG. 3, a white light generating from a light source 30, reflected by a reflector 32, is projected into separation prism 34. The incoming light will be split into three color bands, the red, green, and blue primary colors by selectively reflecting and filtering, and each of these three will be respectively projected onto total reflection prism 36, 38 and 40 along each propagation direction. While, these red, green, and blue colors will be reflected, by total reflection prism 36, 38 and 40, into top prism 42, and will be merged and projected into a camera 44. Finally, these merged light beams will be projected onto the screen, via camera 44, to generate an image thereon. Because of the merit of separation prism 34 for shorting the path of light projection, prism 34 has been widely applied to many kinds of LCD devices.

Referring to FIG. 4, three-dimensional separation prism 34 is illustrated. In one preferred embodiment, separation prism 34 comprises three optical lenses, as the first, second and the third optical lenses 50, 54 and 52 shown in FIG. 4, coated with chemical materials thereon, and is fixed onto a base 56. While the second optical lens 54 is pasted on the axis of the first optical lens 50 with a special included angle generated there-between. The third optical lens 52 is also pasted on the axis of the first optical lens 50 with a special included angle generated there-between and located on the other side opposite to the second optical lens 54. As a result, separation prism 34 can split the incoming light into the red, green, and blue colors and let each of three be guided in each propagation direction. It is noted that the separation prism is made up of three optical lenses in the above-mentioned embodiment, while it can also be made up of four independent lenses pasted with each other to form the separation prism, with a cross shape.

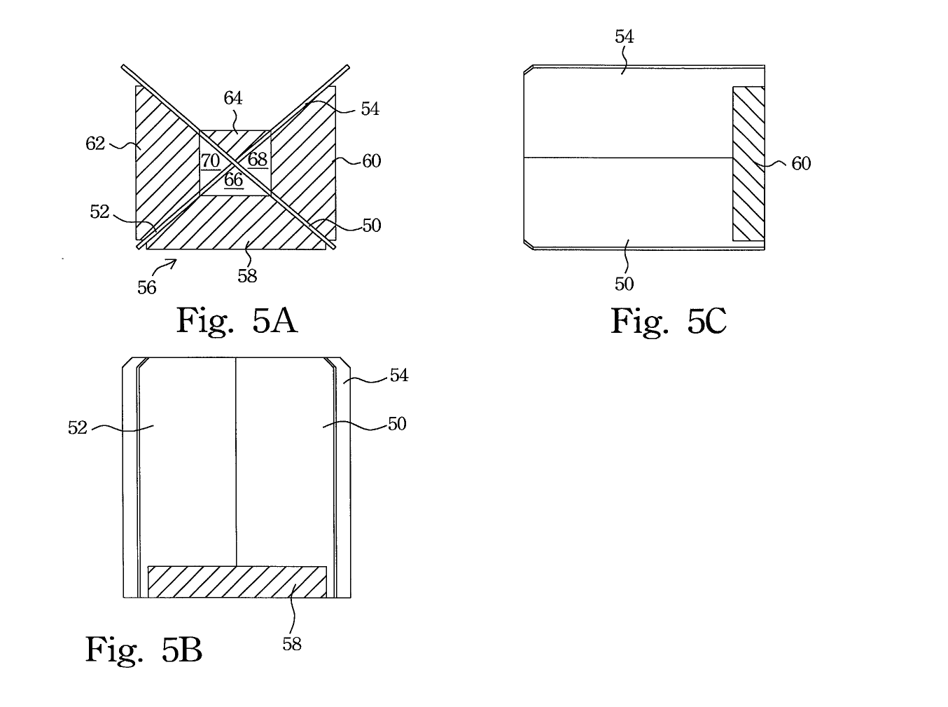

Next referring to FIG. 5A˜5C, a top-view, front-view and side-view of separation prism 34 are illustrated respectively. As shown in FIG. 5A, base 56 comprises of mutually independent based positioning component 64, the first positioning component 58, the second positioning component 60 and the third positioning component 62. Based positioning component 64, a triangular structure, is pasted onto the bottom of the first and the second optical lenses 50 and 54, with glue. The apex of based positioning component 64 coincides with the cross axes of the optical lenses, and the two bevel edges thereof are fit in with two sides of the first and the second optical lenses 50 and 54. Accordingly, the included angle between the optical lenses can be precisely fixed. The first positioning component 58, the second positioning component 60 and the third positioning component 62 are trapezoid structures, while the first positioning component 58 is located opposite to based positioning component 64 and the two bevel edges thereof are pasted and fit in with two sides of the first and the third optical lenses 50 and 52. The second positioning component 60 is located on the side of based positioning component 64 to fix the relative positions of the first and the second optical lenses 50 and 54. The third positioning component 62 is also located on the side of based positioning component 64 to fix the relative positions of the first and the third optical lenses 50 and 52. Moreover, it is noted that the materials of based positioning component 64, the first positioning component 58, the second positioning component 60 and the third positioning component 62 are selected from those which are more rigid as well as not easy to be deformed, such as metals, plastic steel, plastics. The method of adhesion between the optical lens and the positioning component only utilizes normal glue.

Because openings 66, 68 and 67 are formed between the tops of the first, the second and the third positioning component 58, 60 and 62 and the first, the second and the third optical lenses 50, 54 and 52, the air can easily flow through optical lenses to improve the effect of heat dissipation of the separation prism. On the other hand, a vacant space existing between based positioning component 64, the first and the second optical lenses 50 and 54, it will benefit the prism to lean against the based positioning surface, while assembling, and the included angle between different optical lenses can be precisely defined. Finally, optical-lens base 56 can be installed after it has been assembled separately outside the optical instrument to decrease the difficulty of assembly and to increase the precision and the yield rate thereof.

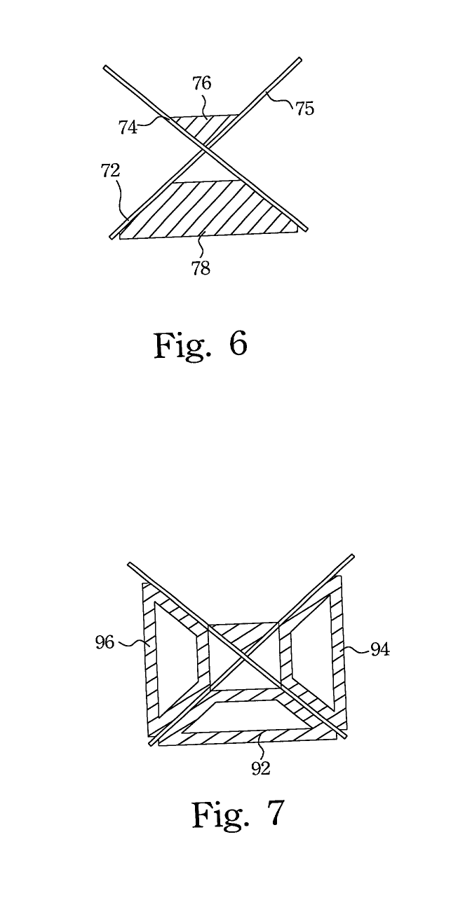

FIG. 6 illustrates another embodiment of separation prism assembly according to the present invention's spirits. As shown in FIG. 6, the structure thereof is almost the same with the above-mentioned embodiment. The main difference between these two is that the present invention's base embodiment is made up of a triangular based positioning component 76 and a trapezoid positioning component 78. The apex of based positioning component 76 coincides with the cross axes of the first and the second optical lenses 74 and 75, and the two bevel edges thereof are fit in with two sides of these two optical lenses. It's easy for the prism to lean against the based positioning surface, while assembling, and the included angle between different optical lenses can be precisely defined. Moreover, positioning component 78 is located opposite to based positioning component 76 and adjacent to the first and the third optical lenses 74 and 72 to set up the relative positions between the optical lenses.

FIG. 7 illustrates another embodiment of separation prism assembly according to present invention's spirits. As shown in FIG. 6, the structure thereof is almost the same with the first embodiment. The main difference between these two is that the contours of the first, the second and the third positioning components 92, 94 and 96 are trapezoid with a central opening for materials of manufacture saved as well as an improved effect of heat dissipation.

Although the invention has been described in detail herein with reference to its preferred embodiment, it is to be understood that this description is by way of example only, and is not to be interpreted in a limiting sense. It is to be further understood that numerous changes in the details of the embodiments of the invention, and additional embodiments of the invention, will be apparent, and may be made by persons of ordinary skill in the art having reference to this description. It is considered that such changes and additional embodiments are within the spirit and true scope of the invention as claimed below.

We claim:

1. An assembly device for separation prism comprising:
a plurality of optical lenses, attached to each other with a cross shape as a separation prism, to split incoming light into three color bands, red, green, and blue by selectively reflecting and filtering, wherein the red, green, blue will be respectively guided along each propagation direction; and
a base, comprising a plurality of mutually independent positioning components, said positioning components being trapezoid to define an included angle between said optical lenses, each of said positioning component located on the bottom of said separation prism and fit in with said optical lenses with the two bevel edges thereof to set up the relative positions between said optical lenses, wherein openings are formed by surrounded with the tops of each said trapezoid positioning component and said optical lenses for easily heat dissipating, generated from the incoming light in said separation prism.

2. The assembly device as recited in claim 1, wherein said optical lenses further comprises a first optical lens, a second optical lens and a third optical lens, said second and said third optical lenses pasted opposite to the two sides of the central line of said first optical lens, for said separation prism assembly, with the cross shape.

3. The assembly device as recited in claim 1, wherein said optical lenses further comprises a first optical lens, a second optical lens, a third optical lens, a fourth optical lens, said first and said fourth optical lenses, said second and said third optical lenses pasted to an axis, for said separation prism assembly, with the cross shape.

4. The assembly device as recited in claim 1, wherein the surface of said optical lens is coated with chemical films for selectively reflecting and filtering the incoming light.

5. The assembly device as recited in claim 1, wherein said base further comprising a based positioning component, with a triangular contour, and a first, a second, a third positioning components, with trapezoid contours, wherein the apex of said triangular contour coincides with the cross axis of said separation prism, and the two bevel edges of said triangular contour are fit in with said optical lenses in between to facilitate said separation prism to lean against the based positioning surface and to fix the included angles between said optical lenses, and said first, said second, said third positioning components are pasted adjacent to the bottom of said optical lenses for setting up the relatives positions of said optical lenses, and a opening is formed on the central area of said first, said second, said third positioning components for easily heat dissipating.

6. The assembly device as recited in claim 5, wherein said first, said second and said third positioning components further comprises a trapezoid contour with a central opening.

7. The assembly device as recited in claim 1, wherein said base further comprises a based positioning component, with a triangular contour, and a first, positioning component, with a trapezoid contour, wherein the apex of said triangular contour coincides with the cross axis of said separation prism, and the two bevel edges of said triangular contour are fit in with said optical lenses in between to facilitate said separation prism to lean against the based positioning surface and to fix the included angles between said optical lenses, and said first positioning component are pasted adjacent to the bottom of said optical lenses for setting up the relatives positions of said optical lenses.

8. An assembly device for separation prism, applied to a liquid crystal display, the assembly device comprising:
a first optical lens;
a second optical lens, pasted onto the axis of said first optical lens, and a first included angle being formed between said first and said second optical lenses;
a third optical lens, pasted onto the axis of said first optical lens and located on the other side opposite to said second optical lens, and a second included angle being formed between said first and said third optical lenses, wherein said first, said second and said third optical lenses are assembled as a separation prism to split incoming light into three color bands, red, green, and blue;
a based positioning component, with a triangular contour and located on the bottoms of said first, said second and said third optical lenses, with trapezoid contours, wherein the apex of said based positioning component coincides with the cross axis of said first and said second optical lenses, and the two bevel edges of said triangular contour are fit in with the sides of said first and said second optical lenses to facilitate said first and said second optical lenses to lean against the based positioning surface and to fix said first included angle;
a first positioning component, with a trapezoid contour and located on the opposite side of said based positioning component, wherein the two bevel edges of said first positioning component are fit in with the sides of said first and said third optical lenses to fix said second included angle;
a second positioning component, with a trapezoid contour and located on the side of said based positioning component to fix the relative positions of said first and said second optical lenses; and
a third positioning component, with a trapezoid contour and located on the side of said based positioning component to fix the relative positions of said first and said third optical lenses, wherein an opening is formed on the tops of said first, said second and said third positioning components to facilitate heat dissipating of said separation prism.

9. The assembly device as recited in claim 8, wherein the surfaces of said first, said second and said third optical lenses are coated with chemical films for selectively reflecting and filtering the incoming light.
